(19) United States
(12) Patent Application Publication
(10) Pub. No.: US 2026/0323342 A1
(43) Pub. Date: Oct. 15, 2026

(54) APPLICATION SERVICE ADAPTATION BASED ON RAN CONDITIONS USING IDENTIFICATION TOKEN

(71) Applicant: Nokia Solutions and Networks Oy, Espoo (FI)

(72) Inventors: Edward GRINSHPUN, Murray Hill, NJ (US); Gábor HANNÁK, Budapest (HU); Bilgehan ERMAN, Murray Hill, NJ (US)

(21) Appl. No.: 19/109,297

(22) PCT Filed: Sep. 7, 2022
(86) PCT No.: PCT/US2022/042729

§ 371 Date: Mar. 6, 2025

(51) Int. Cl. H04W 24/10; H04W 8/26; H04W 76/27

(52) U.S. Cl. CPC H04W 24/10; H04W 8/26; H04W 76/27

(57) ABSTRACT

Systems, methods, and software of adapting an application service. In one embodiment, a Radio Access Network (RAN) controller (404) of a RAN (102) is configured to provide radio service to User Equipment (UE) (106). The RAN controller receives a request from an application service (410) for performance metrics (702) of an application service flow (512) between the application service and an application client hosted by the UE. The RAN controller receives an identification token (701) from the application service that identifies one or more data radio bearers (504) of the RAN serving the application service flow, receives a report message from one or more RAN nodes (402) of the RAN containing the performance metrics for the data radio bearers, and provides the performance metrics to the application service indexed by the identification token. The application service may then be adapted based on the performance metrics.

### TECHNICAL FIELD

Various example embodiments relate to the field of communication systems and, in particular, to radio access networks.

### BACKGROUND

Next generation networks, such as Fifth Generation (5G), denote the next major phase of mobile telecommunications standards beyond Fourth Generation (4G) standards. In comparison to 4G networks, next generation networks may be enhanced in terms of radio access and network architecture. A Radio Access Network (RAN) is part of a mobile communication system that uses radio access technology to provide wireless connectivity to mobile devices or devices with fixed location (e.g., User Equipment (UE)), and connects the mobile devices with a core network to receive services.

5G systems are envisioned to implement time-sensitive applications, such as gaming, Augmented reality (AR) and Virtual Reality (VR), live video streaming, network-assisted control of autonomously guided vehicles (AGV), network-assisted control of mobile robots in a factory, etc. One problem for carriers is to provide efficient operation and optimal use of resources within the RAN in providing services, such as application services. Many times, service degradation experienced by subscribers is due to congestion and signal related issues in the RAN. Thus, the performance of resources in a RAN is integral to delivering a quality experience to a subscriber.

### SUMMARY

Described herein are enhanced mechanisms for managing a RAN. As an overview, an application client on a UE may access an application service over a RAN and other intervening networks. A RAN controller is able to retrieve Key Performance Metrics (KPM) of one or more RAN nodes that serve a session between the application client and the application service, and provide the KPM to the application service (or to its associated provider). KPM may include, for example, UE throughput, packet latency, jitter, or loss, radio resource utilization, etc. A token exchange mechanism is introduced herein where a newly-defined identification token is generated by the UE/application client, and the identification token is known within the RAN and shared with the application service. The identification token is mapped to the KPM collected from the RAN node(s) that serves the session. The application service may therefore correlate the KPM with an application service flow, and the application service may be adapted based on the KPM. One technical benefit is the performance of the application service may be optimized based on RAN conditions to provide an improved experience to a subscriber.

In an embodiment, a RAN controller of a RAN is configured to provide radio service to User Equipment (UE). The RAN controller comprises at least one processor and at least one memory storing instructions that, when executed by the at least one processor, cause the RAN controller at least to receive a request from an application service for performance metrics of an application service flow between the application service and an application client hosted by the UE, receive an identification token from the application service that identifies one or more data radio bearers of the RAN serving the application service flow, receive a report message from one or more RAN nodes of the RAN containing the performance metrics for the data radio bearers, and provide the performance metrics to the application service indexed by the identification token.

In an embodiment, the identification token is composed of one or more temporary identifiers used by the RAN nodes to manage a Radio Resource Control (RRC) connection of the UE.

In an embodiment, the identification token is composed of one or more persistent UE identifiers assigned by the RAN to the UE.

In an embodiment, the instructions that, when executed by the at least one processor, cause the RAN controller at least to send a request to a 5G core network for a mapping between the persistent UE identifiers and at least a UE NG Application Protocol (NGAP) identifier, serving cell identifier, and one or more data radio bearer identifiers, receive the UE NGAP identifier, the serving cell identifier, and the data radio bearer identifiers mapped to the persistent UE identifiers from the 5G core network, send a request to a RAN node, based on the serving cell identifier, for a mapping between the UE NGAP identifier and a Cell Radio Network Temporary Identifier (C-RNTI) granted to the UE, and receive the C-RNTI from the RAN node mapped to the UE NGAP identifier.

In an embodiment, the identification token comprises a custom identification token generated by the application client or the UE.

In an embodiment, the RAN controller is implemented as a near-real time RAN Intelligent Controller (RIC) of an open-RAN compliant RAN architecture.

In an embodiment, a method of providing application service adaptation is disclosed. The method comprises receiving, at a RAN controller of a RAN that provides radio service to a UE, a request from an application service for performance metrics of an application service flow between the application service and an application client hosted by the UE. The method further comprises receiving, at the RAN controller, an identification token from the application service that identifies one or more data radio bearers of the RAN serving the application service flow. The method further comprises receiving, at the RAN controller, a report message from one or more RAN nodes of the RAN containing the performance metrics for the data radio bearers. The method further comprises providing the performance metrics from the RAN controller to the application service indexed by the identification token.

In an embodiment, the method further comprises generating the identification token at the UE or the application client, and providing the identification token from the UE to the application service.

In an embodiment, the method further comprises receiving, at the application service, the identification token from the UE, sending the request from the application service to the RAN controller for the performance metrics of the application service flow, providing the identification token from the application service to the RAN controller, receiving the performance metrics at the application service from the RAN controller indexed by the identification token, and adapting the application service based on the performance metrics.

In an embodiment, the identification token is composed of one or more temporary identifiers used by the RAN nodes to manage a Radio Resource Control (RRC) connection of the UE.

In an embodiment, the method further comprises detecting, at the UE, a mobility event, identifying updated temporary identifiers used by the RAN nodes, generating an updated identification token based on the updated temporary identifiers, and providing the updated identification token from the UE to the application service.

In an embodiment, the identification token is composed of one or more persistent UE identifiers assigned by the RAN to the UE.

In an embodiment, the method further comprises sending a request from the RAN controller to a 5G core network for a mapping between the persistent UE identifiers and at least a UE NG Application Protocol (NGAP) identifier, serving cell identifier, and one or more data radio bearer identifiers, receiving the UE NGAP identifier, the serving cell identifier, and the data radio bearer identifiers mapped to the persistent UE identifiers from the 5G core network, sending a request from the RAN controller to a RAN node, based on the serving cell identifier, for a mapping between the UE NGAP identifier and a Cell Radio Network Temporary Identifier (C-RNTI) granted to the UE, and receiving, at the RAN controller, the C-RNTI from the RAN node mapped to the UE NGAP identifier.

In an embodiment, the identification token comprises a custom identification token generated by the application client or the UE.

In an embodiment, the method further comprises generating, at the application client or the UE, the custom identification token, providing the custom identification token from the UE to the application service, and adding the custom identification token to a bearer context with the RAN for the application service flow.

In an embodiment, a RAN controller of a RAN is configured to provide radio service to User Equipment (UE). The RAN controller comprises a means for receiving a request from an application service for performance metrics of an application service flow between the application service and an application client hosted by the UE, a means for receiving an identification token from the application service that identifies one or more data radio bearers of the RAN serving the application service flow, a means for receiving a report message from one or more RAN nodes of the RAN containing the performance metrics for the data radio bearers, and a means for providing the performance metrics to the application service indexed by the identification token.

In an embodiment, the RAN controller comprises a means for sending a request to a 5G core network for a mapping between the persistent UE identifiers and at least a UE NG Application Protocol (NGAP) identifier, serving cell identifier, and one or more data radio bearer identifiers, a means for receiving the UE NGAP identifier, the serving cell identifier, and the data radio bearer identifiers mapped to the persistent UE identifiers from the 5G core network, a means for sending a request to a RAN node, based on the serving cell identifier, for a mapping between the UE NGAP identifier and a Cell Radio Network Temporary Identifier (C-RNTI) granted to the UE, and a means for receiving the C-RNTI from the RAN node mapped to the UE NGAP identifier.

Other embodiments may include computer readable media, other systems, or other methods as described below.

The above summary provides a basic understanding of some aspects of the specification. This summary is not an extensive overview of the specification. It is intended to neither identify key or critical elements of the specification nor delineate any scope of the particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments are now described, by way of example only, and with reference to the accompanying drawings. The same reference number represents the same element or the same type of element on all drawings.

FIG. 1 illustrates a high-level architecture of a 5G system.

FIG. 2 illustrates a non-roaming architecture of a 5G system.

FIG. 3 illustrates an NG-RAN.

FIG. 4 illustrates a UE accessing an external application service in an illustrative embodiment.

FIG. 5 illustrates connectivity between an application client and an application service in an illustrative embodiment.

FIG. 6 illustrates an application service flow between a UE and an application service over multiple network segments.

FIG. 7 is a signaling diagram illustrating application service adaptation based on RAN conditions in an illustrative embodiment.

FIG. 8 is a block diagram of a RAN controller in an illustrative embodiment.

FIG. 9 is a flow chart illustrating a method of providing application service adaptation in a RAN controller in an illustrative embodiment.

FIG. 10 is a block diagram of an application server in an illustrative embodiment.

FIG. 11 is a flow chart illustrating a method of providing application service adaptation in an application server in an illustrative embodiment.

FIG. 12 is a block diagram of a UE in an illustrative embodiment.

FIG. 13 is a flow chart illustrating a method of providing application service adaptation in a UE in an illustrative embodiment.

FIGS. 14-15 illustrate generation of an identification token in an illustrative embodiment.

FIG. 16 is a signaling diagram illustrating a token refresh procedure in an illustrative embodiment.

FIG. 17 is a flow chart illustrating a method of performing a token refresh procedure in a UE in an illustrative embodiment.

FIG. 18 is a signaling diagram illustrating an IDT mapping procedure in an illustrative embodiment.

FIG. 19 is a flow chart illustrating a method of performing an IDT mapping procedure in a RAN controller in an illustrative embodiment.

FIG. 20 is a signaling diagram illustrating an IDT notify procedure in an illustrative embodiment.

FIG. 21 is a flow chart illustrating a method of performing an IDT notify procedure in a UE in an illustrative embodiment.

FIG. 22 is a block diagram of an O-RAN compliant RAN architecture in an illustrative embodiment.

FIG. 23 illustrates a UE accessing an external application service in another illustrative embodiment.

FIG. 24 is a signaling diagram illustrating application service adaptation based on RAN conditions in an illustrative embodiment.

### DESCRIPTION OF EMBODIMENTS

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

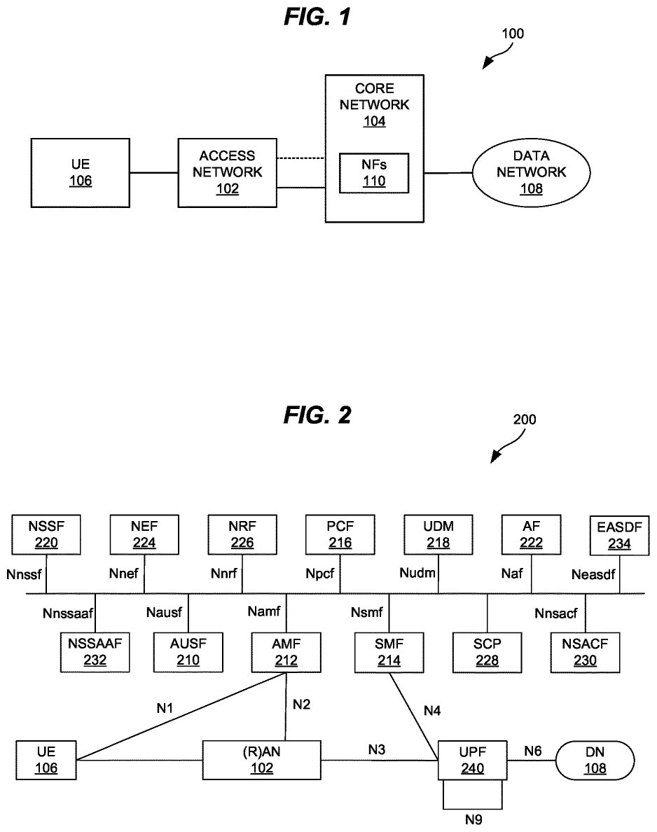

FIG. 1 illustrates a high-level architecture of a 5G system 100. A 5G system 100 is a communication system (e.g., a 3GPP system) comprising a 5G Access Network ((R)AN) 102, a 5G Core Network (CN) 104 (also referred to as 5GC), and 5G User Equipment (UE) 106. Access network 102 may comprise an NG-RAN and/or a non-3GPP access network connecting to a 5G core network 104. Access network 102 may support Evolved-UMTS Terrestrial Radio Access Network (E-UTRAN) access (e.g., through an eNodeB, gNodeB, and/or ng-eNodeB), Wireless Local Area Network (WLAN) access, fixed access, satellite radio access, new Radio Access Technologies (RAT), etc. 5GC 104 interconnects access network 102 with a data network (DN) 108. 5GC 104 is comprised of Network Functions (NF) 110, which may be implemented either as a network element on dedicated hardware, as a software instance running on dedicated hardware, as a virtualized function instantiated on an appropriate platform (e.g., a cloud infrastructure), etc. Data network 108 may be an operator external public or private data network, or an intra-operator data network (e.g., for IMS services). UE 106 is a 5G capable device configured to register with 5GC 104 to access services. UE 106 may be an end user device, such as a mobile phone (e.g., smartphone), a tablet or PDA, a computer with a mobile broadband adapter, etc. UE 106 may be enabled for voice services, data services, Machine-to-Machine (M2M) or Machine Type Communications (MTC) services, and/or other services.

FIG. 2 illustrates a non-roaming architecture 200 of a 5G system. The architecture 200 in FIG. 2 is a service-based representation, as is further described in 3GPP TS 23.501 (v17.4.0), which is incorporated by reference as if fully included herein. Architecture 200 is comprised of Network Functions (NF) for a 5GC 104, and the NFs for the control plane (CP) are separated from the user plane (UP). The control plane of the 5GC 104 includes an Authentication Server Function (AUSF) 210, an Access and Mobility Management Function (AMF) 212, a Session Management Function (SMF) 214, a Policy Control Function (PCF) 216, a Unified Data Management (UDM) 218, a Network Slice Selection Function (NSSF) 220, and an Application Function (AF) 222. The control plane of the 5GC 104 further includes a Network Exposure Function (NEF) 224, an NF Repository Function (NRF) 226, a Service Communication Proxy (SCP) 228, a Network Slice Admission Control Function (NSACF) 230, a Network Slice-specific and SNPN Authentication and Authorization Function (NSSAAF) 232, and an Edge Application Server Discovery Function (EASDF) 234. The user plane of the 5GC 104 includes one or more User Plane Functions (UPF) 240 that communicate with data network 108. UE 106 is able to access the control plane and the user plane of the 5GC 104 through (R)AN 102.

Various network functions of 5G system 100 may also be referred to herein as “network elements” or “network entities”. A network element or network entity includes functions, operations, etc., and the underlying hardware or physical devices (e.g., processors) that are programmed to perform the functions.

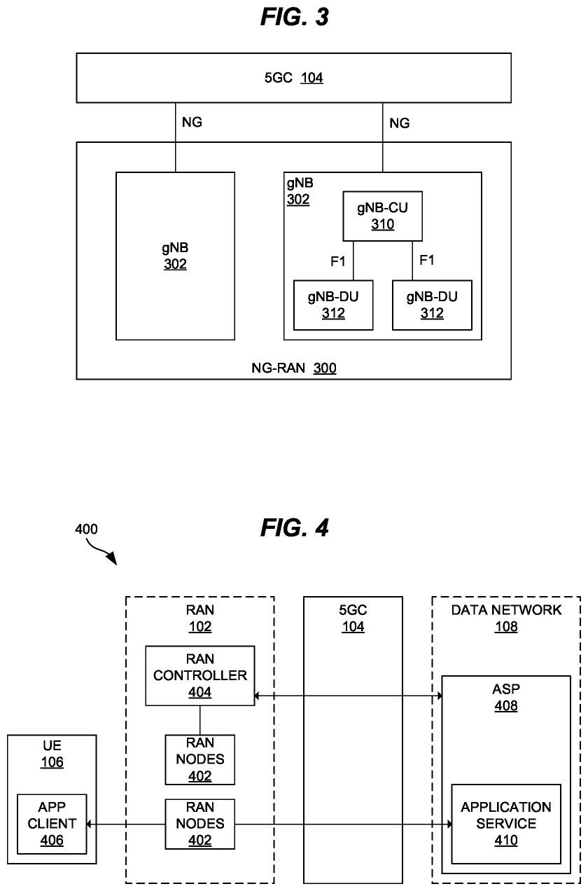

One example of access network 102 in FIG. 1 is an NG-RAN. FIG. 3 illustrates an NG-RAN 300 as described in 3GPP TS 38.401(v 17.1.1 ), which is incorporated by reference as if fully included herein. NG-RAN 300 comprises a set of gNBs 302 connected to 5GC 104 through the NG interface. A gNB 302 (also referred to as gNodeB) is a RAN node that provides New Radio (NR) user plane and control plane protocol terminations towards the UE. A gNB 302 may comprise a gNB Central Unit (gNB-CU) 310, and one or more gNB Distributed Units (gNB-DU) 312. A gNB-CU 310 is a logical node hosting Radio Resource Control (RRC), Service Data Adaption Protocol (SDAP), and Packet Data Convergence Protocol (PDCP) of the gNB that control the operation of one or more gNB-DUs 312. A gNB-DU(s) 312 is a logical node hosting Radio Link Control (RLC), Medium Access Control (MAC), and Physical (PHY) layers of the gNB, and its operation is partly controlled by the gNB-CU 310. One gNB-DU 312 supports one or multiple cells, and one cell is supported by only one gNB-DU 312. A gNB-CU 310 and a gNB-DU 312 are connected via the F1 interface.

A UE 106 or an application client hosted by UE 106 may access an application service on an external data network 108. FIG. 4 illustrates a UE 106 accessing an external application service in an illustrative embodiment. In this example, a 5G system 400 includes a RAN 102 and a 5GC 104 as discussed above. RAN 102 includes one or more RAN nodes 402, which are equipment, hardware, etc., of a RAN 102 that serves a UE 106 (e.g., a gNB, a gNB-CU, a gNB-DU, and/or another type of node implemented in a RAN). An external application service 410 (also referred to as a third-party application service) is implemented in a data network 108, such as by an Application Service Provider (ASP) 408, and is accessible to UE 106 through the 5G system 400. An ASP is an entity (including physical or virtual resources) that offers users or subscribers access to applications and related services over one or more networks. Examples of application service 410 offered by an ASP 408 include, but are not limited to, gaming, AR/VR, live video streaming (e.g., of mass events such as concerts, sport tournaments, etc.), network-assisted control of autonomously guided vehicles (AGV), network-assisted control of mobile robots in a factory, etc.

UE 106 hosts an application client 406. An application client 406 comprises an application (e.g., stand-alone application), component, or executable code that runs on UE 106, and is configured to access an external application service 410.

5G system 400 further includes a RAN controller 404 configured to control or manage one or more of the RAN nodes 402. In an embodiment described herein, RAN controller 404 is configured to collect KPM (also referred to as KPM data or generally as performance metrics) from RAN nodes 402, and provide the KPM to application service 410/ASP 408 as is further described below.

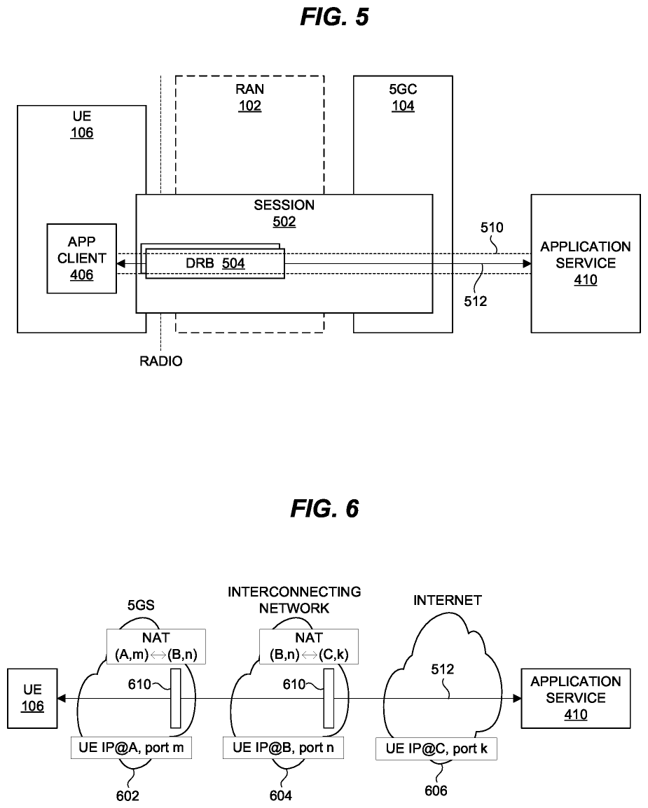

FIG. 5 illustrates connectivity between application client 406 and application service 410 in an illustrative embodiment. UE 106 attaches to RAN 102 over the radio or air interface, and registers with 5GC 104, such as described in the 3GPP specifications. When successfully registered, a session 502 (e.g., a Protocol Data Unit (PDU) session) is established between UE 106 and 5GC 104 via RAN 102. With UE 106 connected to 5GC 104, application client 406 may access application service 410. For example, application client 406 or application service 410 establishes an application connection 510. An application connection 510 is an end-to-end path, link, or pipe between application client 406 and application service 410. To establish the application connection 510, RAN 102 and 5GC 104 provision the appropriate resources of the session 502. For example, RAN 102 may provision or set up one or more Data Radio Bearers (DRB) 504. A DRB 504 is a virtual connection over the radio interface between a UE 106 and a RAN node 402 (e.g., gNB, a gNB-DU, etc.). 5GC 104 may provision or set up a tunnel (e.g., NG tunnel or N3 tunnel) between a RAN node 402 and a UPF 240 of 5GC 104 (not shown in FIG. 5). With the application connection 510 established, an application service flow 512 may be transported between application client 406 and application service 410 over one or more RAN nodes 402, over entities of 5GC 104 (e.g., UPF 240), and other intervening networks. An application service flow 512 is a flow of packets between application service 410 and UE 106/application client 406. As shown in FIG. 5, a portion of the application service flow 512 is transported over a radio segment of RAN 102 via one or more DRBs 504.

In one embodiment, it may be desirable to have interaction between RAN 102 and application service 410/ASP 408 to adapt application service 410 at least in part based on RAN conditions or behavior. As shown in FIG. 4, application service 410 may interact with RAN controller 404 to obtain information on RAN 102, and more particularly, RAN conditions or behavior affecting an application service flow 512. For example, a feedback approach may be used between RAN controller 404 and application service 410/ASP 408. As RAN controller 404 receives reports of KPM from RAN nodes 402 (e.g., user, cell, and/or slice KPM), it may provide the KPM to application service 410/ASP 408. ASP 408 (or functions within application service 410) may then use the KPM to adapt application service 410 in near-real time to RAN conditions, and/or may request special treatment in RAN 102 for the traffic of a specific UE flow.

In order to register for the KPM affecting an application service flow 512, application service 410/ASP 408 needs to be able to specify or indicate the application service flow 512 to RAN controller 404 in a manner that is understood by RAN controller 404. However, there may be no readily-available identifiers known to both application service 410/ASP 408 and RAN controller 404 that can point to a specific application service flow 512. For example, RAN controller 404 may use or process Layer-2 information or identifiers for DRBs 504 that serve an application service flow 512, while application service 410 may use or process higher-layer identifiers or addresses (e.g., Layer-3 or Layer-4). An application service flow 512 may therefore be known to application service 410/ASP 408 by Transmission Control Protocol/Internet Protocol (TCP/IP) information (e.g., UE source IP address and source TCP/UDP port number) received in the IP packet headers of the application service flow 512. If application service 410/ASP 408 were to register with RAN controller 404 with TCP/IP information, for example, RAN controller 404 may not be able to correlate the TCP/IP information with DRBs 504 that carry the application service flow 512.

FIG. 6 illustrates an application service flow 512 between a UE 106 and application service 410 over multiple network segments. An application service flow 512 between UE 106 and application service 410 may be over a 5GS (e.g., RAN 102 and 5GC 104) network access segment 602, an interconnecting network segment 604, and an internet segment 606. In this example, a Network Address Translation (NAT) firewall 610 is implemented at 5GS network access segment 602 and at interconnecting network segment 604, which changes the UE source IP address and port number of IP packets. The UE source IP address and port number of IP packets of the application service flow 512 in 5GS network access segment 602 is different than what is received at application service 410. Thus, RAN controller 404 would be unable to identify a mapping between the TCP/IP information that is known to application service 410 (i.e., IP/port tuple <C, k>) and the TCP/IP information at RAN 102 (i.e., IP/port tuple <A,m>), in part because different segments of the network may be under different administrative domains.

To solve this and/or other potential problems, a token exchange mechanism is introduced herein. As an overview of the token exchange mechanism, an IDentification Token (IDT) is introduced herein that is known within RAN 102 (e.g., by RAN controller 404), and is shared with application service 410/ASP 408. The identification token is an identifier that uniquely identifies one or more DRB(s) 504 of a RAN 102 that serve or carry an application service flow 512 between application client 406 of a UE 106 and an application service 410.

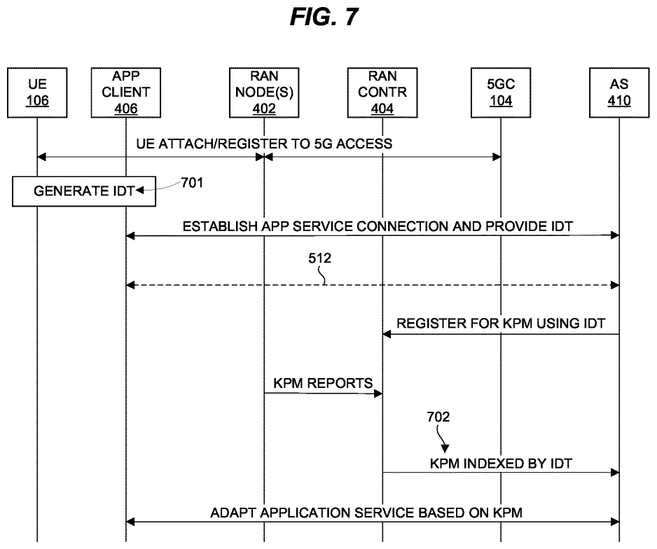

FIG. 7 is a signaling diagram illustrating application service adaptation based on RAN conditions in an illustrative embodiment. UE 106 attaches to RAN 102 (i.e., one or more RAN nodes 402), and registers with 5GC 104. One assumption is that application client 406 hosted by UE 106 wants to access application service (AS) 410. UE 106 or application client 406 generates an identification token (IDT) 701 that is known or discoverable by RAN controller 404 (such as through appropriate mapping). UE 106 or application client 406 interacts with application service 410 to establish an application service connection 510. UE 106 or application client 406 also provides the identification token 701 to application service 410 (and/or ASP 408). An application service flow 512 may then transpire between application client 406 and application service 410. The application service flow 512 is identifiable to application service 410 or ASP 408 via identification token 701, and the portion of the application service flow 512 over the radio segment is identifiable by RAN controller 404 via the identification token 701.

ASP 408 or application service 410 registers for KPM from RAN controller 404 using the identification token 701. RAN nodes 402 report KPM to RAN controller 404 for a DRB(s) 504 that serves the application service flow 512. RAN controller 404 then provides the KPM 702 to ASP 408 or application service 410 indexed by the identification token 701. Based on the identification token 701, application service 410/ASP 408 is able to associate the KPM 702 provided by RAN controller 404 with the application service flow 512. Thus, ASP 408 (or functionalities of application service 410) is able to adapt the application service 410 based on the KPM 702.

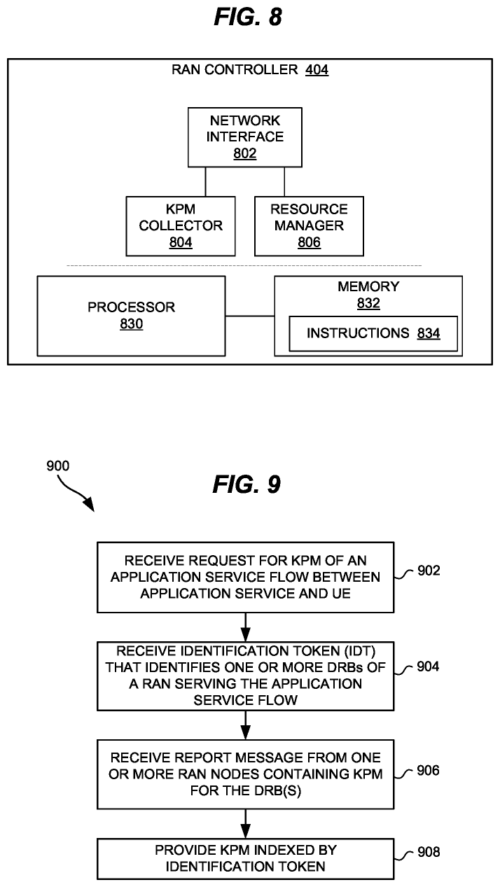

FIG. 8 is a block diagram of a RAN controller 404 in an illustrative embodiment. In this embodiment, RAN controller 404 includes the following subsystems: a network interface component 802, a KPM collector 804, and a resource manager 806. Network interface component 802 is a hardware component that exchanges messages, signaling, or packets with other elements. Network interface component 802 may be configured to communicate over a variety of interfaces or reference points. KPM collector 804 comprises circuitry, logic, hardware, means, etc., configured to acquire or retrieve KPM 702 from one or more RAN nodes 402, and report the KPM 702 to an external entity, such as an ASP 408 or application service 410. Resource manager 806 comprises circuitry, logic, hardware, means, etc., configured to control or manage operations of RAN 102 or a segment of RAN 102, such as for load management or traffic steering, Quality of Experience (QoE) Optimization, Quality of Service (QoS)-based Resource Optimization, MIMO (multiple-input, multiple-output) Optimization, etc.

One or more of the subsystems of RAN controller 404 may be implemented on a hardware platform comprised of analog and/or digital circuitry. One or more of the subsystems of RAN controller 404 may be implemented on one or more processors 830 that execute instructions 834 (i.e., computer readable code) for software that are loaded into memory 832. A processor 830 comprises an integrated hardware circuit configured to execute instructions 834 to provide the functions of RAN controller 404. Processor 830 may comprise a set of one or more processors or may comprise a multi-processor core, depending on the particular implementation. Memory 832 is a non-transitory computer readable storage medium for data, instructions, applications, etc., and is accessible by processor 830. Memory 832 is a hardware storage device capable of storing information on a temporary basis and/or a permanent basis. Memory 832 may comprise a random-access memory, or any other volatile or non-volatile storage device. The term “non-transitory”, as used herein, is a limitation of the medium itself (i.e., tangible, not a signal) as opposed to a limitation on data storage persistency (e.g., RAM vs. ROM). One or more of the subsystems of RAN controller 404 may be implemented on a cloud-computing platform or another type of processing platform. Processor 830, memory 832, and any algorithms (encoded as instructions, programs, or code) may comprise means for providing or causing performance or operation of RAN controller 404.

RAN controller 404 may include various other components or sub-systems not specifically illustrated in FIG. 8.

FIG. 9 is a flow chart illustrating a method 900 of providing application service adaptation in a RAN controller in an illustrative embodiment. The steps of method 900 will be described with reference to RAN controller 404 in FIG. 8, but those skilled in the art will appreciate that method 900 may be performed in other systems, devices, or network functions. The steps of the flow charts described herein are not all inclusive and may include other steps not shown, and the steps may be performed in an alternative order.

For method 900, it is assumed that an application service flow 512 is established between an application client 406 and an application service 410, and one or more DRBs 504 are provisioned or set up within RAN 102 to serve the application service flow 512. KPM collector 804 of RAN controller 404 receives a request from application service 410/ASP 408 for KPM 702 of the application service flow 512 between application service 410 and application client 406 (step 902), such as through network interface component 802. For example, KPM collector 804 may receive a register request from an application service 410/ASP 408 registering for KPM 702 of the application service flow 512. KPM collector 804 also receives an identification token 701 from application service 410/ASP 408 that identifies the DRB(s) 504 of RAN 102 serving the application service flow 512 (step 904). As described above, the identification token 701 was previously provided to application service 410/ASP 408, such as by UE 106, so that application service 410/ASP 408 is able to indicate the identification token 701 when requesting KPM for a particular application service flow 512.

KPM collector 804 collects KPM 702 from RAN nodes 402. The identification token 701 contains information that allows KPM collector 804 to identify a DRB(s) 504 carrying application traffic, and request KPM for these DRBs 504. KPM collector 804 receives a report or report message from one or more RAN nodes 402 containing KPM for the DRBs 504 (step 906), such as through network interface component 802. KPM collector 804 may receive the report periodically or after pre-defined trigger events. KPM collector 804 may previously subscribe to a RAN node 402 indicating KPM that are of interest, and whether the reporting is periodic or trigger-based.

KPM collector 804 associates or correlates the KPM for the DRBs 504 to the identification token 701, and provides the KPM 702 to application service 410/ASP 408 indexed by the identification token 701 (step 908), such as through network interface component 802. For example, KPM collector 804 may send a notify message to application service 410/ASP 408, in response to the register request, containing the KPM 702 for the application service flow 512 and the identification token 701. One technical benefit is the application service 410 may be adapted based on the KPM 702 provided by RAN controller 404.

For example, application service 410 may adapt to the reported KPM 702 by adjusting the amount of traffic it sends/receives through the network (e.g., when network throughput is lower, application service 410 may use lower resolution video encoding). In this case, application service 410/ASP 408 registers to receive the KPM 702, and adapts to the reported network conditions by adjusting the amount/bursts of traffic it sends through the network. In another example, network controller 404 may adjust resources of RAN 102 based on a request from application service 410/ASP 408 (if there are sufficient resources). In this case, application service 410/ASP 408 requests certain treatment for an application service flow 512 (e.g., in terms of throughput, latency, jitter). Network controller 404 (i.e., through resource manager 806) provides resource allocation (e.g., spectral resources in the form of scheduler PRBs in 5G RAN) to satisfy requested application needs, and sends control messages to RAN nodes 402 accordingly.

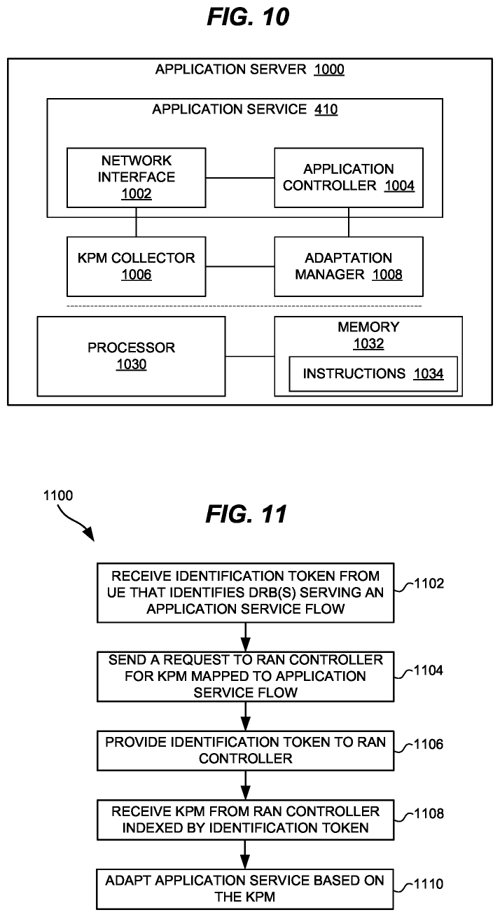

FIG. 10 is a block diagram of application server 1000 in an illustrative embodiment. Application server 1000 is equipment of an ASP 408 configured to provide an application service 410. Application server 1000 may be implemented as a network element on dedicated hardware, as a software instance running on dedicated hardware, as a virtualized function instantiated on an appropriate platform (e.g., a cloud infrastructure), etc. In one embodiment, application server 1000 includes the following subsystems: a network interface component 1002, an application controller 1004, a KPM collector 1006, and an adaptation manager 1008 that operate on one or more platforms. Network interface component 1002 may comprise circuitry, logic, hardware, means, etc., configured to exchange control plane messages or signaling with other network elements or NFs. Network interface component 1002 may operate using a variety of protocols or reference points. Application controller 1004 may comprise circuitry, logic, hardware, means, etc., configured to provide functions, operations, or activities of the application service 410. For example, application controller 1004 may interact with an application client to establish an application service connection, receive data from an application client, send data to an application client, etc. KPM collector 1006 may comprise circuitry, logic, hardware, means, etc., configured to collect KPM 702 for application service flows established for the application service 410. Adaptation manager 1008 may comprise circuitry, logic, hardware, means, etc., configured to adapt the application service 410 based on RAN behavior, measurements (e.g., KPM), conditions, etc., and/or other inputs.

One or more of the subsystems of application server 1000 may be implemented on a hardware platform comprised of analog and/or digital circuitry. For example, application controller 1004, KPM collector 1006, and adaptation manager 1008 may be implemented on one or more processors 1030 that execute instructions 1034 for software that are loaded into memory 1032. One or more of the subsystems of application server 1000 may be implemented on a cloud-computing platform or another type of processing platform.

Application server 1000 may include various other components not specifically illustrated in FIG. 10.

FIG. 11 is a flow chart illustrating a method 1100 of providing application service adaptation in an application server in an illustrative embodiment. The steps of method 1100 in FIG. 11 will be described with reference to application server 1000 as in FIG. 10, but those skilled in the art will appreciate that method 1100 may be performed in other systems or network entities.

For method 1100, one assumption is that application controller 1004 (through network interface component 1002) interacts with application client 406 on UE 106 to establish an application service connection 510, and transmits data to or receives data from application client 406 in an application service flow 512. For example, the application service flow 512 may comprise streaming data, interactive data, etc.

KPM collector 1006 of application server 1000 receives the identification token 701 from UE 106 that identifies the DRB(s) 504 serving the application service flow 512 (step 1102), such as through network interface component 1002. KPM collector 1006 sends a request to RAN controller 404 for KPM mapped to the application service flow 512 between application service 410 and application client 406 (step 1104), such as through network interface component 1002. KPM collector 1006 also provides the identification token 701 to RAN controller 404 (step 1106), in the request or in another message. KPM collector 1006 receives the KPM 702 from RAN controller 404 indexed by the identification token 701 (step 1108), such as through network interface component 1002. For example, KPM collector 1006 may receive a notify message from RAN controller 404, in response to a register request, containing the KPM 702 for the application service flow 512 and the identification token 701. The KPM are therefore mapped to the application service flow 512 based on the identification token 701. Adaptation manager 1008 then adapts the application service 410 based on the KPM 702 (step 1110). In other words, adaptation manager 1008 is able to adapt the application service 410 based on network conditions in RAN 102. In one example, adaptation manager 1008 may adjust the amount of traffic application service 410 sends/receives through the network (i.e., adjust traffic of the application service flow 512 over DRB(s) 504)). In another example, adaptation manager 1008 may send a request to RAN controller 404 for certain treatment for the application service flow 512. One technical benefit is the application service 410 may be optimized or adjusted based on RAN conditions, such as to provide QoE optimization.

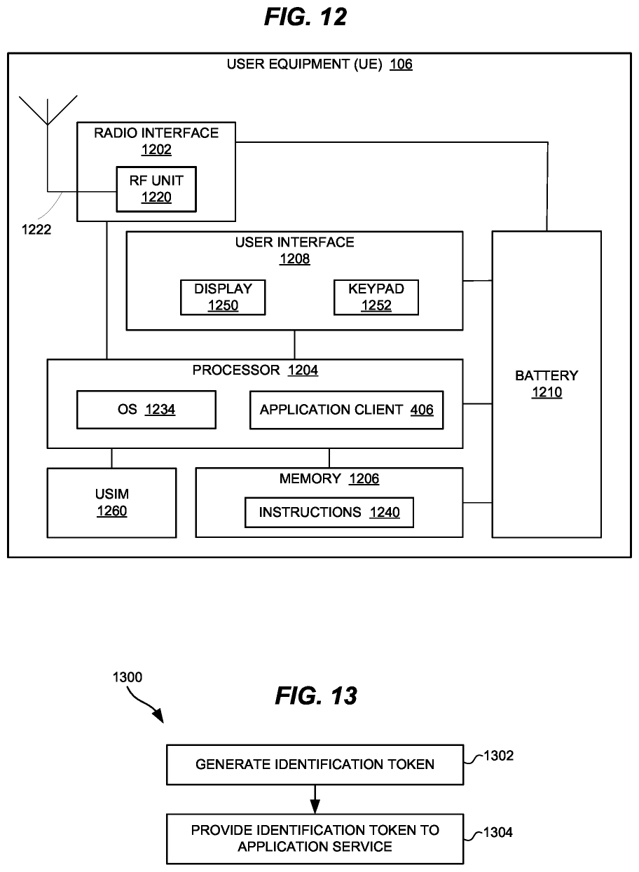

FIG. 12 is a block diagram of a UE 106 in an illustrative embodiment. UE 106 includes a radio interface component 1202, one or more processors 1204, a memory 1206, a user interface component 1208, and a battery 1210. Radio interface component 1202 is a hardware component that represents the local radio resources of UE 106, such as an RF unit 1220 (e.g., one or more radio transceivers) and one or more antennas 1222. Radio interface component 1202 may be configured for WiFi, Bluetooth, 5G NR, LTE, etc. Processor 1204 represents the internal circuitry, logic, hardware, etc., that provides the functions of UE 106. Processor 1204 may be configured to execute instructions 1240 for software that are loaded into memory 1206. Processor 1204 may execute an Operating System 1234 for UE 106 that manages hardware and software resources, and one or more application clients 406. User interface component 1208 is a hardware component for interacting with an end user. For example, user interface component 1208 may include a display 1250, screen, touch screen, or the like (e.g., a Liquid Crystal Display (LCD), a Light Emitting Diode (LED) display, etc.). User interface component 1208 may include a keyboard or keypad 1252, a tracking device (e.g., a trackball or trackpad), a speaker, a microphone, etc. UE 106 also includes a Universal Subscriber Identity Module (USIM) 1260, which is an integrated circuit that provides security and integrity functions for UE 106. USIM 1260 includes or is provisioned with a subscription profile associated with a subscription of a subscriber. A subscription profile may include a variety of information, such as subscription credentials (e.g., a Subscription Permanent Identifier (SUPI)) used to uniquely identify a subscription and to mutually authenticate the UE 106 and a network.

UE 106 may include various other components not specifically illustrated in FIG. 12.

FIG. 13 is a flow chart illustrating a method 1300 of providing application service adaptation in a UE 106 in an illustrative embodiment. The steps of method 1300 in FIG. 13 will be described with reference to UE 106 as in FIG. 12, but those skilled in the art will appreciate that method 1300 may be performed in other systems or network entities.

For method 1300, one assumption is that application client 406 on UE 106 or application service 410 initiates an application service connection 510. UE 106 or application client 406 generates an identification token 701 that is known or discoverable by RAN controller 404 (step 1302). UE 106 or application client 406 then provides the identification token 701 to application service 410/ASP 408 (step 1304). For example, UE 106 or application client 406 may interact with application service 410 to establish the application service connection 510. UE 106 or application client 406 may provide the identification token 701 to application service 410 in a service establishment request, in subsequent handshaking messages, etc.

In one embodiment, the identification token 701 may be composed of one or more temporary identifiers used by RAN nodes 402 to manage an RRC connection of UE 106, and known to the UE 5G radio layer. For example, the identification token 701 may be composed of one or more of the following temporary identifiers: a serving cell ID, a UE ID, a DRB ID or drb-identity, and Cell Radio Network Temporary Identifier (C-RNTI) granted to UE 106 by a RAN node 402 (e.g., a tuple <Serving cell id, UE id, DRB id, C-RNTI>). In another example, the identification token 701 may be composed of one or more of the following temporary identifiers: a serving cell ID, a network slice ID, a C-RNTI, and a 5G QoS Identifier (5QI) (e.g., a tuple <Serving cell id, network slice id, C-RNTI, 5QI>). Other temporary identifiers or combinations of temporary identifiers may be used to form the identification token 701.

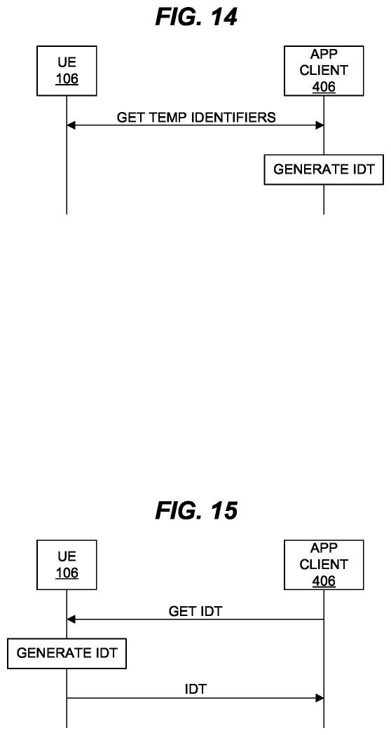

FIGS. 14-15 illustrate generation of an identification token 701 in an illustrative embodiment. In FIG. 14, application client 406 is tasked with generating the identification token 701. UE 106 (e.g., through operating system 1234) identifies one or more temporary identifiers used by RAN nodes 402 to manage an RRC connection, and provides the temporary identifiers to application client 406. Application client 406 then generates or creates the identification token 701 as described above based on the temporary identifiers. In FIG. 15, UE 106 (e.g., through operating system 1234) is tasked with generating the identification token 701. UE 106 receives a request from application client 406 for the identification token 701. In response, UE 106 identifies one or more temporary identifiers used by RAN nodes 402 to manage an RRC connection, generates or creates the identification token 701 as described above based on the temporary identifiers, and provides the identification token 701 to application client 406.

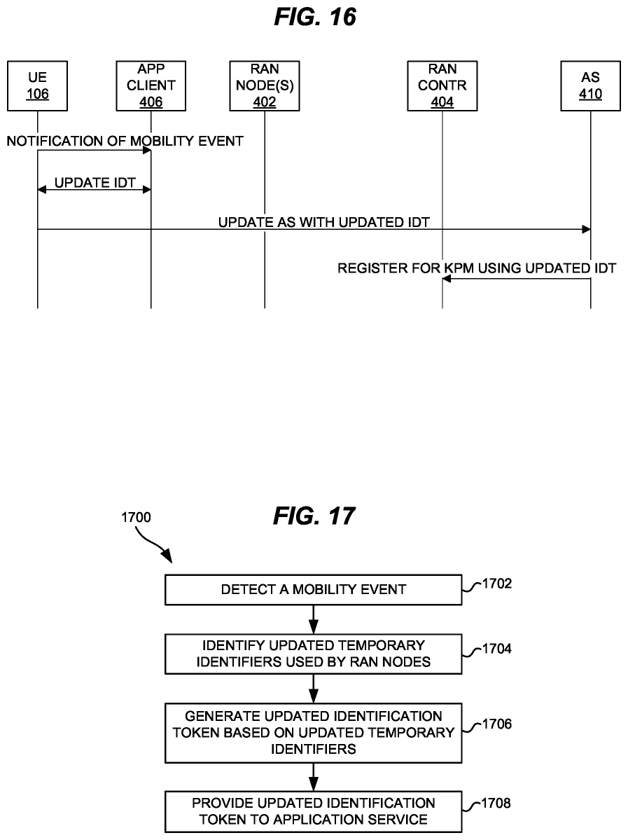

When temporary identifiers are used to construct the identification token 701, the temporary identifiers may change during the lifetime of the application service flow 512 due to mobility events or the like (e.g., when the serving cell changes). Thus, a token refresh procedure may be used to inform application service 410/ASP 408 of an updated identification token. FIG. 16 is a signaling diagram illustrating a token refresh procedure in an illustrative embodiment. FIG. 17 is a flow chart illustrating a method 1700 of performing a token refresh procedure in a UE 106 in an illustrative embodiment. UE 106 detects a mobility event (step 1702), and identifies one or more updated temporary identifiers used by RAN nodes 402 (step 1704). UE 106 or application client 406 generates or creates an updated identification token 701 based on the updated temporary identifiers (step 1706). UE 106 then provides the updated identification token 701 to application service 410 (step 1708). Application service 410 may then update its registration with RAN controller 404 to receive KPMs associated with the updated identification token 701.

In one embodiment, an identification token 701 may be composed of persistent UE identifiers assigned by the RAN 102, and available via UE APIs. For example, the identification token 701 may be composed of one or more of the following persistent UE identifiers: a UE IP address and TCP/IP port number (e.g., a tuple <UE IP address, TCP/IP port number>). In another example, the identification token 701 may be composed of one or more of the following persistent UE identifiers: a UE Global Unique Temporary Identifier (GUTI) or Subscription Concealed Identifier (SUCI), and TCP/IP port number (e.g., a tuple <UE GUTI or SUCI, TCP/IP port number >). Other persistent UE identifiers or combinations of persistent UE identifiers may be used to form the identification token 701. UE 106 or application client 406 may be tasked with generating or creating an identification token 701 based on persistent UE identifiers, as described above for temporary identifiers in FIGS. 14-15.

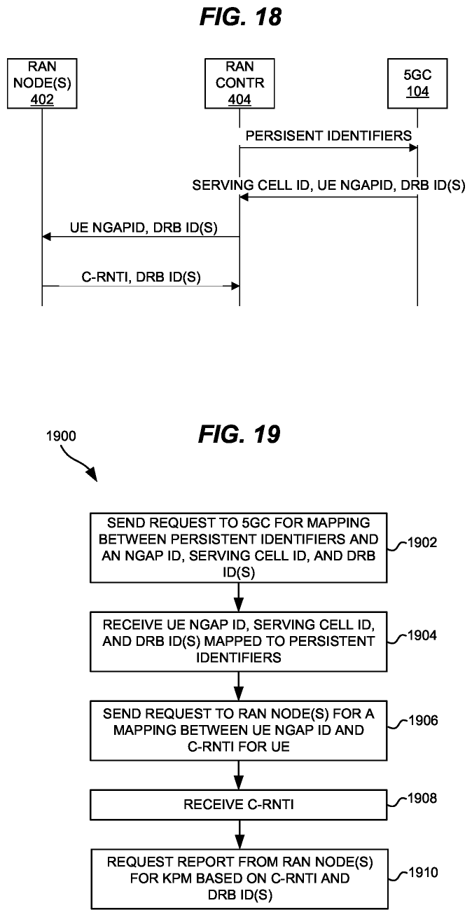

When persistent UE identifiers are used to construct the identification token 701, RAN controller 404 may perform an IDT mapping procedure to correlate the persistent UE identifiers of the identification token 701 to one or more DRBs 504 that serve an application service flow 512. FIG. 18 is a signaling diagram illustrating an IDT mapping procedure in an illustrative embodiment. FIG. 19 is a flow chart illustrating a method 1900 of performing an IDT mapping procedure in a RAN controller 404 in an illustrative embodiment. One assumption is KPM collector 804 of RAN controller 404 receives a request from application service 410/ASP 408 for KPM 702 regarding the application service flow 512, and receives an identification token 701 that identifies the DRB(s) 504 serving the application service flow 512 (see steps 902 and 904 of FIG. 9). When the identification token 701 is composed of persistent UE identifiers, KPM collector 804 sends a request to 5GC 104 for a mapping between the persistent UE identifiers (e.g., UE IP address, GUTI, SUCI, TCP/IP port number, etc.) and a UE NG Application Protocol (NGAP) ID, serving cell ID, DRB ID(s), and/or other information (step 1902). KPM collector 804 receives the UE NGAP ID, serving cell ID, DRB ID(s), etc., mapped to the persistent UE identifiers from 5GC 104 (step 1904). KPM collector 804 then sends a request to one or more RAN nodes 402, based on the serving cell ID, for a mapping between the UE NGAP ID and a C-RNTI for UE 106 (step 1906). The C-RNTI is a unique identification used for identifying RRC Connection and scheduling that is dedicated to a particular UE 106. A gNB, for example, assigns different C-RNTI values to different UEs. The gNB uses a C-RNTI to allocate a UE 106 with uplink grants, downlink assignments, etc. KPM collector 804 receives the C-RNTI from the RAN nodes 402 (step 1908), and uses the C-RNTI, DRB ID(s), and other information to collect KPM 702 for application service 410 by requesting a report from the RAN nodes 402 (step 1910).

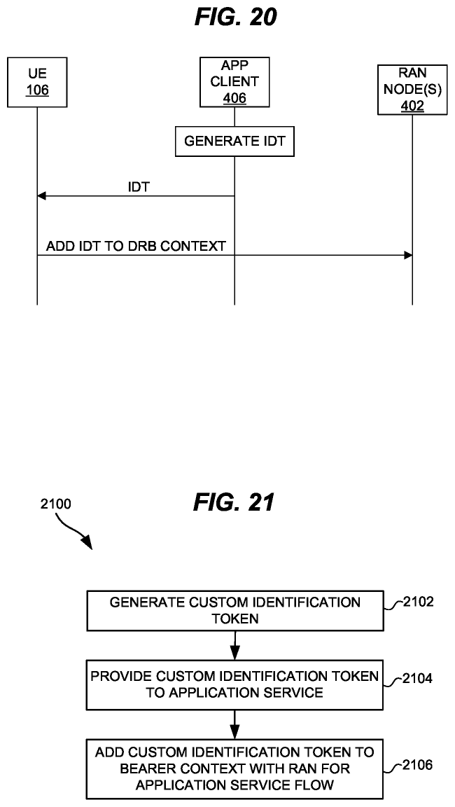

In one embodiment, the identification token 701 may comprise a custom identifier generated by application client 406 or UE 106, and communicated by UE 106 to RAN nodes 402 via a new 3GPP extension and stored by RAN nodes 402. FIG. 20 is a signaling diagram illustrating an IDT notify procedure in an illustrative embodiment. FIG. 21 is a flow chart illustrating a method 2100 of performing an IDT notify procedure in a UE 106 in an illustrative embodiment. Method 2100 may supplement method 1300 as described in FIG. 13. In this example, UE 106 or application client 406 generates or creates a custom identification token 701 (step 2102). A custom identification token is generated by a UE 106 or application client 406, and cannot be derived by another entity (e.g., RAN controller 404). For example, a custom identification token may be based on a random value, a pseudo-random value, a value generated based on an algorithm, etc. The custom identification token 701 may be unique per serving cell ID, and uniqueness per serving cell may be achieved, for example, by incorporating time-of-day with millisecond accuracy. UE 106 or application client 406 provides the custom identification token 701 to application service 410/ASP 408 (step 2104).

UE 106 also provides the custom identification token 701 to RAN 102. For example, UE 106 may add the custom identification token 701 to a bearer context or UE context with RAN 102 for the application service flow 512 (step 2106). To do so, 3GPP protocols may be extended to include the custom identification token 701 in a bearer context or UE context. The serving cell may reject the custom identification token 701 if it is not unique, and the procedure may be repeated then until the serving cell accepts the custom identification token 701. RAN nodes 402, in turn, will provide reports to RAN controller 404 containing KPM for the DRBs 504 mapped to the custom identification token 701.

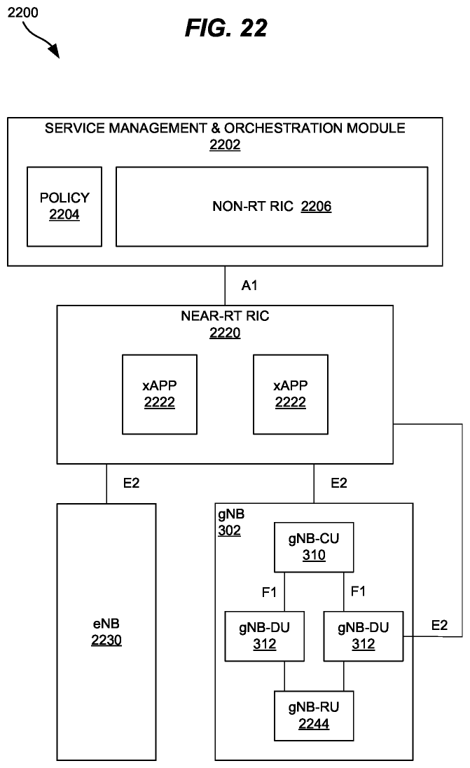

In one embodiment, a RAN 102 as described above may be compliant with open-RAN (O-RAN) as suggested by the O-RAN alliance. FIG. 22 is a block diagram of an O-RAN compliant RAN architecture 2200 in an illustrative embodiment. O-RAN is an evolution of a Next Generation RAN (NG-RAN) architecture, such as provided by the 3GPP in TS 38.401. RAN architecture 2200 includes a Service Management and Orchestration (SMO) module 2202 configured to manage network functions. SMO module 2202 includes policy control function 2204 and a non-real-time RAN Intelligent Controller (non-RT RIC) 2206, which is a logical function that enables non-real-time control and optimization of RAN elements and resources, Artificial Intelligence (AI)/Machine Learning (ML) workflow including model training and updates, and policy-based guidance of applications/features.

RAN architecture 2200 further includes a near-real time RIC (near-RT RIC) 2220, which is a logical function that enables near-real-time control and optimization of O-RAN elements and resources via fine-grained data collection and actions. RAN architecture 2200 further includes an eNB 2230 and a gNB 302. In this example, gNB 302 includes a gNB-CU 310, one or more gNB-DUs 312, and a gNB Radio Unit (gNB-RU) 2244. A gNB-RU 2244 is a logical node hosting Low-PHY layer and Radio Frequency (RF) processing based on a lower layer functional split.

In one embodiment, RAN controller 404 as discussed above may comprise a near-RT RIC 2220. Near-RT RIC 2220 is deployed at the edge of the network. Whereas non-RT RIC 2206 operates on a time scale longer than one second, near-RT RIC 2220 drives control loops with RAN nodes with a time scale between ten milliseconds and one second. In other embodiments, RAN controller 404 may comprise a non-RT RIC 2206, or a combination of a near-RT RIC 2220 and a non-RT RIC 2206.

Near-RT RIC 2220 includes one or more applications that support custom logic, referred to as xApps 2222. An xApp 2222 is a microservice used to perform radio resource management through standardized interfaces and service models. An xApp 2222 receives KPM from RAN nodes 402 (e.g., gNB CU 310 and/or gNB DU 312), and provides control actions to RAN nodes 402.

The E2 interface is used between near-RT RIC 2220 and RAN nodes 402, such as gNB CU 310 and gNB DU 312 (which may also be referred to as E2 nodes). The E2interface allows near-RT RIC 2220 to control procedures and functionalities of the RAN nodes 402, and allows for collection of KPM from the RAN nodes 402. Control and/or data collection may pertain to one or more cells, slices, QoS classes, or specific UEs. The E2interface provides an E2 report service. The E2 report service is activated upon subscription from an xApp 2222 to a function offered by a RAN node 402. The xApp 2222 may specify trigger events or the periodicity with which the RAN node 402 should send report messages. When an event is detected or a timer expires, a RAN node 402 sends a report message (also referred to as an RIC Indication message) to the xApp 2222 with KPM.

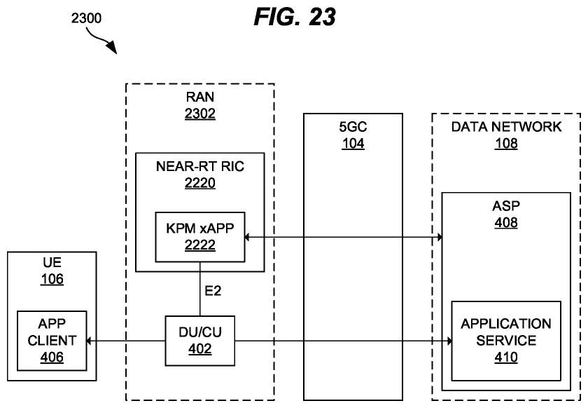

FIG. 23 illustrates a UE 106 accessing an external application service in another illustrative embodiment. In this example, a 5G system 2300 includes an O-RAN compliant RAN 2302 and a 5GC 104 as discussed above. RAN 2302 again includes one or more RAN nodes 402 illustrated as a gNB-CU 310 and a gNB-DU 312. An external application service 410 is implemented in a data network 108 by an ASP 408, and is accessible to UE 106 through the 5G system 2300. Near-RT RIC 2220 includes a KPM xAPP 2222 configured to control or manage one or more of gNB-CU 310 and a gNB-DU 312. KPM xAPP 2222 may use the E2 report service to subscribe to reports from gNB-CU 310 and a gNB-DU 312. In turn, KPM xApp 2222 receives report messages (e.g., RIC Indication message of type “report”) from gNB-CU 310 and a gNB-DU 312 with KPM.

An O-RAN compliant RAN architecture 2200 as in FIG. 22 may use a variety of identifiers for the control and data collection procedures. For example, 3GPP identifiers may be used for gNB (gNB-ID), slice (slice-ID), and QoS class (QCI). A common user identifier (i.e., UE-ID) may be used for the UE 106, which provides a uniform user identity without exposing sensitive information related to the user. However, these identifiers do not indicate application-level flows of a UE 106. For example, if a UE 106 hosts multiple application clients 406, the UE-ID cannot be used to distinguish one application service flow from another. Thus, the token exchange mechanism may be used as described above where an identification token is known or discoverable by KPM xAPP 2222 and provided to application service 410/ASP 408.

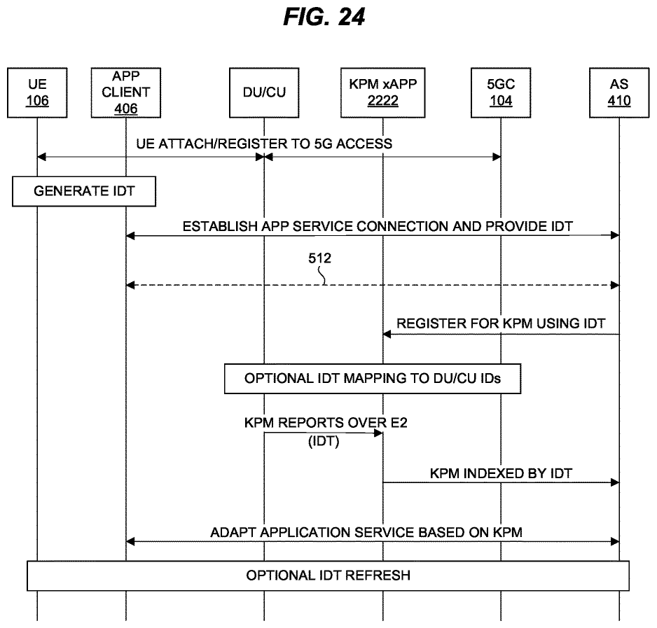

FIG. 24 is a signaling diagram illustrating application service adaptation based on RAN conditions in an illustrative embodiment. Application service adaptation may be used for certain use cases, such as QoE improvement. UE 106 attaches to RAN 2302, and registers with 5GC 104. One assumption is that application client 406 hosted by UE 106 wants to access application service (AS) 410. UE 106 or application client 406 generates an identification token (IDT) 701 that is known or discoverable by KPM xAPP 2222. The identification token 701 is in addition to the DRB-ID in the RIC E2 interface context. UE 106 or application client 406 interacts with application service 410 to establish an application service connection 510 (see FIG. 5). UE 106 or application client 406 also provides the identification token 701 to application service 410/ASP 408. An application service flow 512 may then transpire between application client 406 and application service 410. The application service flow 512 is identifiable to application service 410/ASP 408 via identification token 701, and the portion of the application service flow 512 over the radio segment is identifiable by KPM xAPP 2222 via the identification token 701. When the identification token 701 is constructed from persistent UE identifiers, an optional IDT mapping procedure may be performed to correlate the persistent UE identifiers of the identification token 701 to one or more DRBs 504 that serve an application service flow 512 as in FIG. 18.

Application service 410/ASP 408 registers for KPM from KPM xAPP 2222 using the identification token 701. The identification token 701 contains information that allows KPM xApp 2222 to identify DRBs 504 carrying application traffic, and request KPM from gNB-CU 310 and a gNB-DU 312 for these DRBs 504. The gNB-CU 310 and gNB-DU 312 report KPM to KPM xAPP 2222 over the E2 interface, and the KPM for a DRB(s) 504 are mapped to the identification token 701. KPM xAPP 2222 then provides the KPM to application service 410/ASP 408 indexed by the identification token 701. Based on the identification token 701, application service 410/ASP 408 is able to associate the KPM provided by KPM xAPP 2222 with the application service flow 512. Thus, ASP 408 is able to adapt the application service 410 based on the KPM 702.

When temporary identifiers are used to construct the identification token 701, the token refresh procedure may be used to inform application service 410/ASP 408 of an updated identification token as described in FIG. 16.

Any of the various elements or modules shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

As used in this application, the term “circuitry” may refer to one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although specific embodiments were described herein, the scope of the disclosure is not limited to those specific embodiments. The scope of the disclosure is defined by the following claims and any equivalents thereof.

1-15. (canceled)

16. A Radio Access Network (RAN) controller (404) of a RAN (102) configured to provide radio service to User Equipment (UE) (106), the RAN controller comprising:
at least one processor (830); and
at least one memory (832) storing instructions that, when executed by the at least one processor, cause the RAN controller at least to:
receive a request from an application service (410) for performance metrics (702) of an application service flow (512) between the application service and an application client hosted by the UE;
receive an identification token (701) from the application service that identifies one or more data radio bearers (504) of the RAN serving the application service flow;
receive a report message from one or more RAN nodes (402) of the RAN containing the performance metrics for the data radio bearers; and
provide the performance metrics to the application service indexed by the identification token.

17. The RAN controller of claim 16, wherein:
the identification token is composed of one or more temporary identifiers used by the RAN nodes to manage a Radio Resource Control (RRC) connection of the UE.

18. The RAN controller of claim 16, wherein:
the identification token is composed of one or more persistent UE identifiers assigned by the RAN to the UE.

19. The RAN controller of claim 18, wherein the instructions that, when executed by the at least one processor, cause the RAN controller at least to:
send a request to a 5G core network (104) for a mapping between the persistent UE identifiers and at least a UE NG Application Protocol (NGAP) identifier, serving cell identifier, and one or more data radio bearer identifiers;
receive the UE NGAP identifier, the serving cell identifier, and the data radio bearer identifiers mapped to the persistent UE identifiers from the 5G core network;
send a request to a RAN node, based on the serving cell identifier, for a mapping between the UE NGAP identifier and a Cell Radio Network Temporary Identifier (C-RNTI) granted to the UE; and
receive the C-RNTI from the RAN node mapped to the UE NGAP identifier.

20. The RAN controller of claim 16, wherein:
the identification token comprises a custom identification token generated by the application client or the UE.

21. The RAN controller of claim 16, wherein:
the RAN controller is implemented as a near-real time RAN intelligent controller (2220) of an open-RAN compliant RAN architecture (2200).

22. A method (900), comprising:
receiving (902), at a Radio Access Network (RAN) controller of a RAN that provides radio service to User Equipment (UE), a request from an application service for performance metrics of an application service flow between the application service and an application client hosted by the UE;
receiving (904), at the RAN controller, an identification token from the application service that identifies one or more data radio bearers of the RAN serving the application service flow;
receiving (906), at the RAN controller, a report message from one or more RAN nodes of the RAN containing the performance metrics for the data radio bearers; and
providing (908) the performance metrics from the RAN controller to the application service indexed by the identification token.

23. The method of claim 22, further comprising:
generating (1302) the identification token at the UE or the application client; and
providing (1304) the identification token from the UE to the application service.

24. The method of claim 23, further comprising:
receiving (1102), at the application service, the identification token from the UE;
sending (1104) the request from the application service to the RAN controller for the performance metrics of the application service flow;
providing (1106) the identification token from the application service to the RAN controller;
receiving (1108) the performance metrics at the application service from the RAN controller indexed by the identification token; and
adapting (1110) the application service based on the performance metrics.

25. The method of claim 22, wherein:
the identification token is composed of one or more temporary identifiers used by the RAN nodes to manage a Radio Resource Control (RRC) connection of the UE.

26. The method of claim 25, further comprising:
detecting (1702), at the UE, a mobility event;
identifying (1704), at the UE, updated temporary identifiers used by the RAN nodes;
generating (1706), at the UE, an updated identification token based on the updated temporary identifiers; and
providing (1708) the updated identification token from the UE to the application service.

27. The method of claim 22, wherein:
the identification token is composed of one or more persistent UE identifiers assigned by the RAN to the UE.

28. The method of claim 27, further comprising:
sending (1902) a request from the RAN controller to a 5G core network for a mapping between the persistent UE identifiers and at least a UE NG Application Protocol (NGAP) identifier, serving cell identifier, and one or more data radio bearer identifiers;
receiving (1904), at the RAN controller, the UE NGAP identifier, the serving cell identifier, and the data radio bearer identifiers mapped to the persistent UE identifiers from the 5G core network;
sending (1906) a request from the RAN controller to a RAN node, based on the serving cell identifier, for a mapping between the UE NGAP identifier and a Cell Radio Network Temporary Identifier (C-RNTI) granted to the UE; and
receiving (1908), at the RAN controller, the C-RNTI from the RAN node mapped to the UE NGAP identifier.

29. The method of claim 22, wherein:
the identification token comprises a custom identification token generated by the application client or the UE.

30. The method of claim 29, further comprising:
generating (2102), at the application client or the UE, the custom identification token;
providing (2104) the custom identification token from the UE to the application service; and
adding (2106), at the UE, the custom identification token to a bearer context with the RAN for the application service flow.
